(19) United States
(12) Patent Application Publication
(10) Pub. No.: US 2005/0167313 A1
(43) Pub. Date: Aug. 4, 2005

(54) Container and label for such container

(76) Inventor: David Annetts, Hertfordshire (GB)

Correspondence Address: MORGAN LEWIS & BOCKIUS LLP, 1111 PENNSYLVANIA AVENUE NW, WASHINGTON, DC, 20004, US

(21) Appl. No.: 10/514,448

(22) PCT Filed: May 14, 2003
(86) PCT No.: PCT/EP03/05218

(30) Foreign Application Priority Data
May 17, 2002 (GB) 0211285.2

(51) Int. Cl. B65D 85/00

(52) U.S. Cl. 206/459.5

(57) ABSTRACT

A container (1) which enables the contents of the container to be viewed in the environment in which they may be used, particularly useful as a paint can (1), a label for use in the production of such a can is also provided.

The present invention relates to containers and in particular to containers that can display the content of the container in the environment in which it might be used. In particular the invention relates to paint cans which are able to show the colour of the paint within the can in an environment such as a living room, kitchen or bedroom in which it might be used. By use of the container of the invention a potential purchaser and/or user of the paint is assisted in deciding if the particular colour and/or shade of the paint is appropriate.

Transparent paint cans which display the content of the can are known, similarly it is known to display artwork on the outside of a paint can depicting an environment within which the paint may be used. It is also known to provide a chip on the outside of a can showing the colour of the paint when dry after application.

We have now developed a container which enables the contents of a container to be shown to potential consumers in a manner that shows how it interacts with a real life situation. The container is therefore able to demonstrate how the contents will work in the context of life. The containers are particularly useful as paint cans.

The present invention therefore provides a container comprising an externally visible depiction of an environment within which the contents of the container may be used and a window that enables the nature of the contents of the container to be blended into said environment.

The container of the present invention is preferably a plastic can produced by injection moulding. The container is preferably made entirely of transparent material. Polyethylene being a preferred material. The environment within which the contents of the container will be used may be printed onto the container itself preferably during the manufacture of the container in the mould by a technique known as in mould labelling. In this technique the interior surface of the mould acts as a printing machine.

In our preferred process however the depiction of the environment in which the contents of the container are to be used is provided by means of a label which can be attached to the exterior of the container. The label is preferably a self-adhesive label. The label may be printed in a manner that depicts the environment in which the contents of the container are to be used and, at the same time, is provided with a transparent window which enables a potential purchaser and/or user to view the content of the container through the transparent window in the label and the transparent wall of the can.

The labels may also be printed and designed to provide any desired effect. For example the label may be printed to depict a life situation such as a kitchen, bedroom or living room containing furniture and perhaps human images. The colour of the part of the label that is used to depict the life situation may be selected to catch the eye of the potential purchaser who is looking for a particular colour for example red, green or yellow and once drawn to the can by this colour environment the potential purchaser then has the opportunity to view a series of shades of the colour in question through the transparent windows in the containers.

The labels may also be used to provide other artwork and written materials. For example they may contain directions for use of the contents of the container and may also contain health and safety data as is required with certain materials such as paint.

The labels may also be used to provide a particular aesthetic effect to the exterior of the container. For example different parts of the label may be used to provide different effects. We particularly prefer to use a label which provides a metallic coloured impression over part of the area of the container. In such a situation the label which is preferably based on transparent thermoplastic material such as polyethylene terephthalate film is partially metallised and may then be over printed with a particular colour to provide a metallised colour, such as metallic blue or green effect. We prefer that where such an effect is incorporated into the label it be such that it provides the metallised effect to the lower portion of the container. The label may also be used to show the brand name of the contents of the container and in our preferred system which employs the metallised colour we prefer that the brand name be displayed on the metallised colour portion of the label. In this way the brand name appears on the lower section of the container and is not obscured by the handle of the container.

Accordingly a preferred label according to the present invention consists of an upper portion which is used to depict the environment within which the contents of the container will be used in which there is a transparent window which exposes the contents of the container, the label further consists of a lower portion which preferably is of a darker colour than the colour depicting the environment within which the contents of the container will be used.

The lower portion may also be used for branding and may be metallised as described. The border between the upper and lower portions of the label may be used to further enhance the aesthetic impression of the container. For example it may be of a wavy configuration which can be designed to provide a continuos wavy effect on rows of contiguous cans on shop shelves. Where the container is a paint can, the configuration can also be selected to depict the texture and applicability of the paint.

In our preferred system the label also carries the instructions for the use of the contents of the container, health and safety data and any other written materials. These are preferably positioned on the label so that they can be at the back of the container when it is located on shop shelves.

In the preferred embodiment of the present invention which is concerned with paint containers it is preferred that the depiction of the environment within which the paint will be used is somewhat blurred to provide a vignetted effect. It is also preferred that the artwork on the can gives the impression of the consistency and spreadability of the paint which may be achieved by the wavy configuration at the boundary between the upper and lower portions of the label.

In a further embodiment of a paint can according to the invention, a colour chip is provided on the outside of the can showing the colour provided by the paint within the can when dry which in some instances can be somewhat different from the colour/shade in the can. It is also preferred that this chip be integrated with the artwork showing the environment within which the contents will be used. In our preferred system the chip lies close to or lies across the boundary between the upper and lower portions of the label. The chip may correspond to the colour chips provided in colour charts and in particular to the colour charts described in our copending UK Patent Application 0211974.1.

The present invention is illustrated by the accompanying drawings in which:

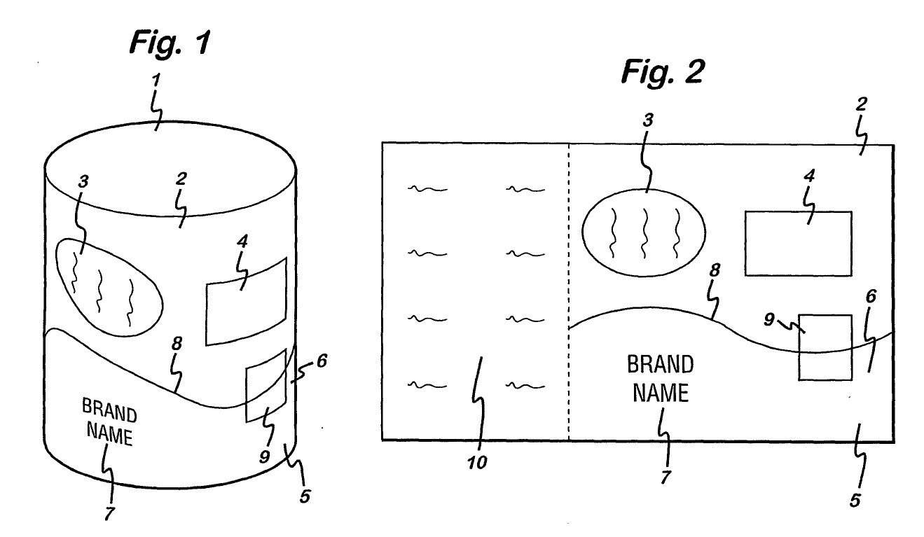

FIG. 1 shows the front of a paint can according to the present invention.

FIG. 2 shows a self adhesive label which can be used to provide the artwork and written materials to be applied to the exterior of a can.

FIG. 1 shows the front of a transparent, polyethylene can (1) to which has been applied the label of FIG. 2. The exterior appearance of the can is in two sections an upper section (2) which contains a depiction of the environment in which the paint will be used (3) and a transparent window (4) through which the contents of the can may be viewed and assimilated with the depiction (3). The lower portion of the can (5) consists of a darker colour background (6) upon which may be printed the brand name (7) and/or other promotional material. The boundary between the upper and lower portions is provided by the wavy line (8). A colour chip (9) showing the colour of the paint when dry is provided bridging the boundary between the upper and lower portions of the can.

FIG. 2 shows the flat label which may be placed around the can to provide the front of the can as shown in FIG. 1 and also shows how the label itself may be in two sections one part of which provides the material for the front of the can as illustrated in FIG. 1 and the other section provides written material (10) such as directions for use and health and safety materials.

Although the cans are illustrated as being cylindrical they may be square or rectangular or they may be tapered. Cylindrical is preferred.

As a further embodiment the invention provides the labels which are used to produce the cans of the present invention.

The invention therefore provides a label comprising two sections divided vertically one section carrying written material and the other section carrying artwork, the section carrying artwork being divided horizontally into two sections an upper section carrying artwork depicting a human environment and provided with a transparent window and the lower section being of a darker colour than the upper section.

It is preferred that the labels are provided with an adhesive layer on the backside of the label. It is further preferred that the section carrying written material and the lower section of the section carrying artwork consist of colouring deposited on metallised film.

In a further preferment when the label is to be used for a paint can it is preferred that it carry a colour chip indicating the colour of the particular paint with which it is to be used when dry. It is also preferred that the lower darker section of the second section of the label carry a brand name.

The labels of the present invention are preferably based on polyethylene terephthalate film which may be metallised, printed and supplied with an adhesive layer by conventional means.

1. A container comprising an externally visible depiction of an environment within which the contents of the container may be used and a window that enables the nature of the contents of the container to be blended into said environment.

2. A container according to claim 1 in which the depiction of the environment within which the contents of the container are to be used is provided by means of a label which can be attached to the exterior of the container.

3. A container according to claim 2 in which the label is printed in a manner that depicts the environment in which the contents of the container are to be used and is provided with a transparent window which enables a potential purchaser and/or user to view the content of the container through the transparent window in the label and the transparent wall of the container.

4. A container according to claim 2 or claim 3 in which the labels provides other artwork and written materials.

5. A container according to claim 4 in which the other written material comprises directions for use of the contents of the container and/or contain health and safety data.

6. A container according to claim 2 in which the label provides a metallic coloured impression over part of the area of the container.

7. A container according to claim 6 in which the label provides the metallised effect to the lower portion of the container.

8. A container according to claim 7 in which the brand name of the contents of the container is displayed on the metallised colour portion of the label.

9. A label comprising an upper portion which is used to depict the environment within which the contents of the container may be used in which there is a transparent window which exposes the contents of the container, the label further consists of a lower portion which preferably is of a darker colour than the colour depicting the environment within which the contents of the container will be used.

10. A label according to claim 9 in which the border between the upper and lower portions of the label further enhances the aesthetic impression of the container.

11. A label according to claim 10 in which the border has a wavy configuration.

12. A label according to claim 9 also carrying the instructions for the use of the contents of the container and health and safety data.

13. A label according to claim 9 in which the depiction of the environment within which the contents of the container will be used is blurred to provide a vignetted effect.

14. A paint can or label according to claim 1 or claim 9 in which a colour chip is provided on the outside of the can showing the colour provided by the paint within the can when dry.

15. A label comprising two sections divided vertically one section carrying written material and the other section carrying artwork, the section carrying artwork being divided horizontally into two sections an upper section carrying artwork depicting a human environment and provided with a transparent window and the lower section being of a darker colour than the upper section.

16. A label according to claim 15 provided with an adhesive layer on the backside of the label.

17. A label according to claim 15 or claim 16 in which the section carrying written material and the lower section of the section carrying artwork consist of colouring deposited on metallised film.

18. A label according to claim 15 which carries a colour chip indicating the colour of the particular paint with which it is to be used when dry.
